(19) United States
(12) Patent Application Publication
(10) Pub. No.: US 2025/0022034 A1
(43) Pub. Date: Jan. 16, 2025

(54) SYSTEMS AND METHODS FOR FAST-TRACK DELIVERY OF ADD-ON GOODS TO CUSTOMERS AT CHECKOUT LOCATIONS OF A PHYSICAL STORE

(71) Applicant: Kirubakaran Services Corporation, Saratoga, CA (US)

(72) Inventors: Kirubakaran Periyannan, Saratoga, CA (US); Saraswathi Periyannan, Coimbatore (IN)

(73) Assignee: Kirubakaran Services Corporation, Saratoga, CA (US)

(21) Appl. No.: 18/220,953

(22) Filed: Jul. 12, 2023

(51) Int. Cl. G06Q 30/0601

(52) U.S. Cl. CPC G06Q 30/0631; G06Q 30/0633

(57) ABSTRACT

A machine-implemented method keeps confidential track of shopping behaviors of customers at brick-and-mortar stores and reminds them at checkout time of items they probably forgot to bring to the checkout register. In accordance with one aspect, there is provided a machine-implemented method that lets customers elect to have certain ones of the forgotten items rushed to them before the customers leave the store; and more particularly even before the customer leaves the checkout register. By certain ones of the forgotten items it is meant here that those certain items are in-stock at the store and can be rushed to the respective customers within a predetermined or calculated time limit.

### BACKGROUND

Physical shopping at a brick-and-mortar store differs from online virtual shopping at least in that the customer has to commute physically to the brick-and-mortar store, typically has to physically pick and place the goods into a shopping cart, has to transport the filled cart to a checkout register, wait in a queue for the register, and has to pay for the goods at the checkout register before leaving the store with those purchased goods. By contrast, online virtual shopping does not require a customer to commute to a specific location, does not require the customer to transport a filled cart of physical goods to a checkout register and does not require the customer to leave the online shopping site while in possession of purchased goods.

One frustration that shoppers at physical stores may experience is that of leaving a particular store, starting their commute to another location and thereafter realizing they forgot to include a needed item in their shopping cart. As a result, they may have to go back to the particular store and repeat the process of getting a cart, placing the forgotten item in the cart and waiting again in a checkout line just so they can acquire the forgotten item. Examples of forgotten items may include that of a shopper having forgotten to place his/her favorite brand of fresh milk into the supermarket cart when the milk at home has been finished or spoiled, that of the customer having forgotten to pick up a bottle of vitamins at the drug store after the at-home supply ran out, the customer having neglected to snap up some AAA-sized batteries at the local hardware store for her child's toy or perhaps she forgot to buy a birthday gift for a friend while at a general department store located in a large mall with an adjacent parking lot. Each case may result not only in frustration for the customer after she already left the particular store or venue but also in undesirable consumption of extra time and fuel (or other energy source) for all involved if the customer has to return to the same store (or to a like other store) to purchase the missed item. This results in an increase of number of customers waiting on line at the checkout counters 13 because some are returnees purchasing their respectively forgotten items. It also results in extra work for the checkout clerks. And it results in detriment to the environment, for example in the form of increased vehicular traffic and additional pollution due to returnees commuting back to the store.

It would be advantageous to have a system that automatically reminds customers, while they are still at the particular brick-and-mortar store or at the venue of that store (e.g., parking lot, an encompassing shopping mall) that perhaps they forgot to purchase a needed item. Then they could get the item before leaving the store or venue. A problem with this aspiration though, is how to technically accomplish such a result in a low cost and practical manner.

It is to be understood that some concepts, ideas and problem recognitions provided in this description of the Background may be novel rather than part of the prior art.

### BRIEF SUMMARY

In one embodiment in accordance with the present disclosure, there is provided a machine-implemented method that keeps confidential track of shopping behaviors of customers at brick-and-mortar stores and reminds them at checkout time of items they are probably forgetting to bring to the checkout register.

More generally, there is provided a machine-implemented method that detects presence of respective customers at respective brick-and-mortar stores and reminds the detected customers at or before checkout time of respective items the respective customers are probably forgetting to bring to respective checkout locations, where the machine-implemented method comprises: (a) detecting presence of a subject customer at a respective brick-and-mortar store that has one or more checkout locations; (b) creating for the subject customer, a pare-down-able list of items the subject customer routinely purchases at the respective brick-and-mortar store and under a current context of subject customer; (c) detecting items that the subject customer is having registered for purchase at a current checkout location and deleting from the pare-down-able list, substantially matching ones if any of the detected items that the subject customer is having registered; (d) determining which, if any, of remaining items in the pare-down-able list are fast-track deliverable items based on the store's current inventory, the fast-track deliverable items being ones that can be delivered to the subject customer before that customer leaves the respective brick-and-mortar store or a surrounding venue of that store; and (e) advising the subject customer as to the availability of the fast-track deliverable items.

In accordance with one extension of the above aspect, the machine-implemented method further (f) lets the subject customer elect to have certain ones of the forgotten items rushed to him or her before that customers leaves the store; and more particularly even before the customer leaves a checkout register location. By certain ones of the forgotten items it is meant here that those certain items are in-stock at the store and can be timely delivered to the respective customers before that customer wants to leave the store or register area; and more particularly within a predetermined or calculated time limit that is convenient for the customer. In one embodiment, the time limit is fifteen minutes (15 min.) or less. In an embodiment, the time limit is five minutes or less. For other embodiments, depending on context, the time limit could be as little as 60 seconds or as large as 30 minutes (e.g., the latter involving charging an electrical vehicle or fueling a large diesel truck).

In one embodiment, there is provided a machine system that automatically keeps confidential track (e.g., by use of encrypted transmissions) of shopping behaviors of customers at brick-and-mortar stores and that automatically reminds them at checkout time of items they may have forgotten to bring to the checkout register. In accordance with one extension of this aspect, there is provided a machine system that lets customers elect to have certain ones of the forgotten items rushed to them before the customers leave the store. The certain ones are those of the forgotten items are those that are in-stock at the store and can be rushed to the respective customers within a predetermined or calculated time limit. In one embodiment, the time limit is seven minutes or less. The machine system includes communication devices that facilitate the rushing of the certain ones of the forgotten items to a location of the customer while still at the store. In one embodiment, the machine system further includes conveyance devices for rush delivering the certain ones of the forgotten items to a location of the customer within the predetermined or calculated time limit.

In one embodiment, there is provided an automated fast tracking system for delivering to a subject customer at a brick-and-mortar store, an add-on item to be added to items already registered for the subject customer at a checkout register of the brick-and-mortar store where the system comprises: (a) an automated fast-track (FT) managing system that receives information about the items already registered for the subject customer and in response returns to a memory device of the system, a pare-down-able list of items the subject customer routinely purchases at the brick-and-mortar store or its type of store and under a current context of the subject customer (e.g., where context includes time of day or day of week); (b) a first list reducer that compares the items already registered for the subject customer versus the items in the pare-down-able list of items and removes from the pare-down-able list those of its items that are substantially matched by the items already registered; (c) a second list reducer that determines if remaining items in the pare-down-able list of items are currently in-stock for the brick-and-mortar store and removes from the pare-down-able list those of its items that are not in-stock; (d) a fast-track order placer that automatically places an order for an item in the pare-down-able list that is currently in-stock and has been requested by the subject customer as a fast-track add-on; and (e) a fast-track delivery mechanism responsive to the fast-track order placer and structured to deliver the requested fast-track add-on item to the subject customer before the subject customer leaves the store or the store's venue and preferably within a predetermined time limit.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate like elements.

FIG. 1 is an introductory schematic diagram of an exemplary environment for which embodiments of the present disclosure can enable fast-track delivery of goods to a customer at a checkout location.

FIG. 2 is a flowchart of a shopping enhancement method in accordance with the present disclosure.

FIGS. 3A-3B respectively illustrate first and second at-checkout counter displays for reminding a customer of possibly forgotten goods that can be fast-track delivered to the customer before the customer leaves the brick-and-mortar store.

FIG. 4 is a schematic of a data processing system that may be used for implementing various parts of the disclosed technology.

FIG. 5 is a flowchart showing further details of an embodiment of the shopping enhancement method.

FIG. 6 is a flowchart showing yet further details of an embodiment of the shopping enhancement method.

### DETAILED DESCRIPTION

The present disclosure relates to technology using resources of wired and/or wireless data processing networks, including a customer tracking database system and optionally, personal mobile communicators to enable recommendation-making to customers and fast-track delivery of recommended goods to a customer before the customer leaves the store and more particularly, even before the customer leaves a checkout location of the physical store. The term “fast-track delivery” as used herein may vary in definition depending on context. The context may take into account the type of brick-and-mortar store venue involved, the types of goods involved, the types and numbers of checkout locations in current operation (e.g., self-check versus clerk serviced and primary versus secondary checkouts). The context may also take into account the number of other customers in line for checkout at the respective spots and other such factors. In some circumstances, “fast-track delivery” may require delivery of a recommended product to the checkout location of the customer in 7 minutes or less, in 5 minutes or less, or within 180 seconds. Other alike but shorter or longer time limits are contemplated here (e.g., from 30 seconds to 30 minutes) and their magnitudes may vary depending on the type of store involved, types of customers involved and the contextual states of those stores and/or customers. For example, customers at one type of store may be willing to wait for longer periods than at other types of stores. The contextually-based determination of such maximum allowed times for “fast-track delivery” may optionally take into account the number of other customers waiting in line behind a fast-track delivery-requesting customer, the type of product being requested and/or the urgency with which the fast-track delivery-requesting customer needs the product.

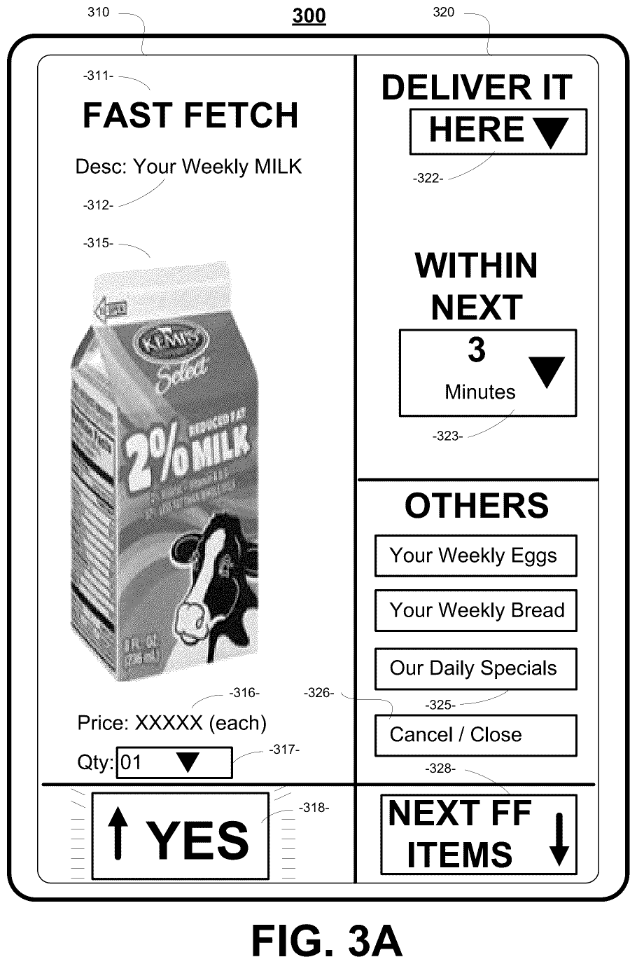

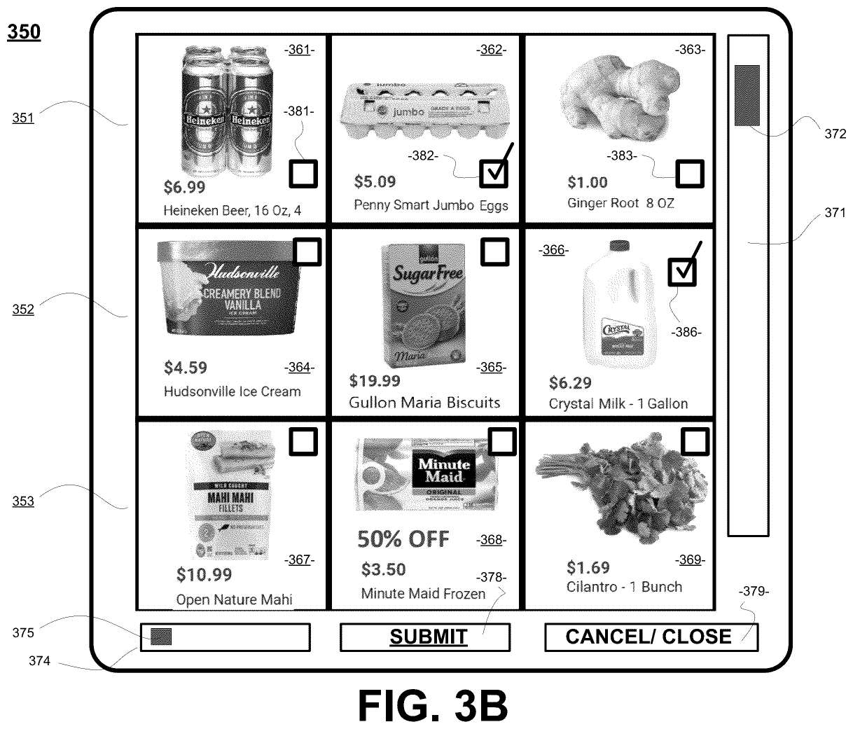

While one example given here relates to shopping at a supermarket where the customer has forgotten to include her favorite brand and type of milk, bread, eggs, etc. (see briefly item 315 in FIG. 3), the present teachings are not to be limited to just this example. There are many different types of brick-and-mortar shopping venues which may benefit from making available to their customers fast-track delivery of forgotten or otherwise desirable goods while the customer is still at the venue. The other brick-and-mortar shopping venues may include, but are not limited to: boutique stores within large shopping malls (where the customer may have to walk long distances from a mall entrance to a specific boutique store); gas station convenience stores; a cluster of stores within short walking distance of a fuel and/or energy dispensing center; drug stores, pet stores, beauty supply stores, hardware stores, office supply stores and so on.

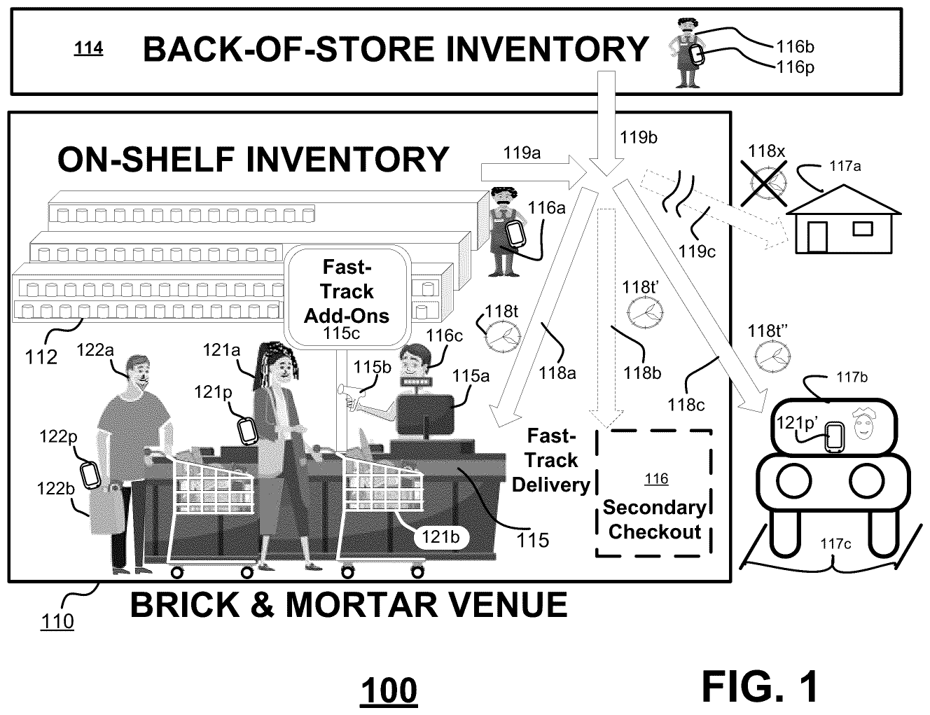

FIG. 1 illustrates an exemplary environment (e.g., a retail supermarket venue) 100 to which the disclosed teachings may be advantageously applied. For this environment, a uniquely identifiable customer (e.g., 121a) may have travelled from a distant home 117a, or from a work place or another such location via a combination of walking and mass transit (e.g., bus, train, taxi, etc.) and/or via their own automobile or other vehicle 117b, where the latter vehicle is left at a nearby parking spot 117c of the venue. The subject customer 121a may have entered the store, fetched an empty shopping cart 121b (or basket e.g., 122b), walked about a customer-accessible area 110 of the store in which customer-accessible shelves 112 are provided and on which customer-selectable products (e.g., in sealed containers and some optionally refrigerated) are placed. The customer may have browsed among the shelves, picked out specific items from the on-shelf inventory and placed them in his or her shopping cart 121b and/or basket 122b and/or other such portable support means.

After filling the cart/basket/etc. (e.g., 121b/122b) with items listed on her shopping list or items recalled from memory, the customer 121a will have proceeded to a checkout counter 115. Usually there will be a queue of other customers waiting ahead of the described customer. Typically the checkout counter 115 will be located near an exit door leading out of the store. The in-line customers will generally plan to leave the store after being processed at the illustrated checkout counter 115. The described customer 121a will often have to wait for her turn at the register 115a. In the illustrated example of FIG. 1, a first store clerk 116c uses a barcode and/or QR code scanning tool 115b (e.g., optical scanner) to scan the items present in the customer's cart 121b and/or basket. For some items, the clerk may enter the product code and/or description via a keyboard. Alternatively, the customer may do her own scanning at a self-checkout location (not shown). The self-check usually does not allow for keyboard entry of registration data. The barcode scan readings are automatically converted by one or more checkout computing devices 115a (also referred to as checkout registration devices 115a) into a digitized and recorded listing of about-to-be-purchased items. (Registration is a cancellable operation and does not always lead to purchase. For example, the customer may have forgotten to bring her purse.) The listing of registered items may include product descriptions, quantities of each, prices for each and applicable discounts (e.g., for pre-identified members of a discounts receiving group). A total amount due is then displayed to the customer (e.g., 121a) on a primary display monitor of the checkout registration devices 115a and the customer is then expected to pay by cash, credit or other means to consummate the purchase. As part of the checkout process, the customer (e.g., 121a) will have been identified to the checkout registration devices 115a (or to an associated other data processing device controlled by the store) on the basis of one or more customer-identifying mechanisms, including but not limited to: the customer having presented a bar-encoded or QR-encoded ID card for scanning at the registration location; the customer having entered her telephone number via a keypad coupled to the registration devices 115a (or the clerk does it for her), the customer having swiped or otherwise scanned in her credit card into a card reader coupled to the registration device 115a, by way of wireless signals picked up from the customer's personal mobile phone 121p or from another wireless customer identifying device and/or by way of automated facial or other biometric recognition.

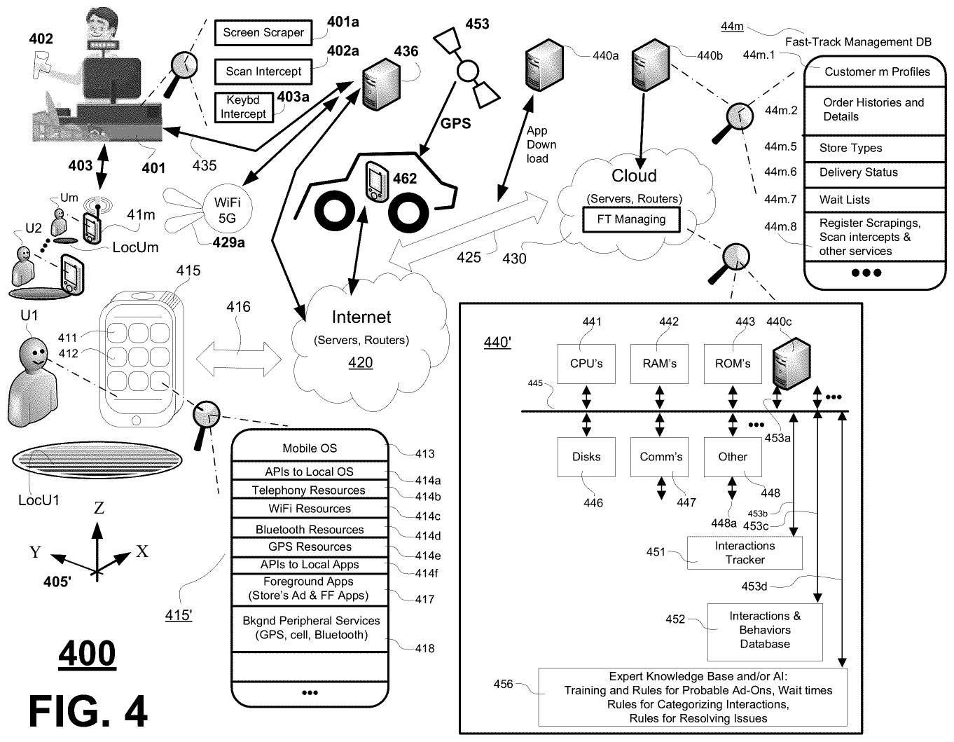

In accordance with one aspect of the present disclosure, the customer's obtained identification is automatically sent to a database system (e.g., preferably via encrypted transmission to an in-cloud system, not shown, see briefly FIG. 4) together with time stamps of when registration began and when it ended. Also, an identification of the store 100 and of the checkout registration devices 115a currently being used to service that customer will be sent. In response, the database system (not shown in FIG. 1) returns a listing of goods that the specific customer 121a normally (routinely) purchases at that type of store (100) or at that specific store and for the current time period (e.g., day of the week or part of year and/or time of day) and/or based on other context-defining factors (e.g., where the customer was before entering the store, how the customer commuted to the store, current weather conditions, current traffic conditions, etc.). The database-system-returned listing (not shown) is automatically pared down to remove from it items that substantially match those currently present in the checkout listing generated by the checkout registration devices 115a. This can then reveal the products that the customer normally purchases at that type of store and under the current contextual situation but at the moment the subject customer may have forgotten to include on her shopping list or to otherwise place in her shopping cart 121b based on her memory. (By ‘substantially matching’ it is meant here that the in-cart item is a suitable substitute for what the customer more routinely purchases, for example, Brand B milk in a small container rather than her usual Brand A milk in a larger container.)

In accordance with one aspect of the present disclosure, certain ones of the missed products in the pared-down listing will be displayed to the customer on a fast-trackable add-ons displaying monitor 115c (see also briefly FIG. 3). Although FIG. 1 shows a separate add-ons displaying monitor 115c it is within the contemplation of the present disclosure for the primary display of the checkout registration devices 115a (e.g., typically these are displays with resolution of 800×600 color pixels or better and more typically 1600×900 color pixels or better) to temporarily function as the add-ons suggesting display. In the latter case, the number of suggested add-ons will vary depending on screen resolution; the suggestion(s) pop out as a cancellable menu after all in-cart items are registered and the pop-out menu disappears upon requesting one or more add-ons or cancelling the menu. When the suggested add-on(s) are displayed, the customer is given the option of selecting one or more of the displayed fast-trackable add-on items via touch activation on the add-ons display monitor 115c and/or by other suitable selection means (e.g., identifying them on her personal mobile phone 121p, asking the clerk 116c to do it, etc.). Alternatively the customer or store clerk can cause the display of the suggested add-ons to disappear. By “certain ones of the missed products”, it is meant here that an automatically and repeatedly updated computer file identifies those certain products as being currently in stock in the store venue either on the shelves 112 or from a back of store inventory area 114 and readily fetchable for delivery to the customer while the customer is still at the store (or at the venue, for example inside a parking lot adjacent to the store or inside a shopping mall that contains the store). If the items are not in stock, they cannot be fast-track delivered to the customer before the customer leaves the venue and more particularly for some embodiments, timely delivered to the customer's current location at the checkout counter 115 (or to a nearby alternate area 116, 117c). As a result, the not-timely deliverable items will not be listed as fast-track deliverable add-ons on display monitor 115c. In one embodiment, the add-ons displaying monitor 115c at the point-of-sale (POS) location (e.g., the primary registration location 115 or at a nearby secondary registration location 116 has a display area much larger (e.g., 8× or greater) than that of a 2023 Apple iphone 12 model so that the add-on advertisements can be easily seen by the subject customer 121a. Preferably that relatively large add-ons displaying monitor 115c has a display resolution of at least 1K and more preferably, of at least 4K so that the add-on advertisements can be seen at high fidelity (high definition or HD) by the subject customer 121a. It is within the contemplation of the present disclosure for the add-ons display to be alternatively or additionally projected by an augmented reality (AR) wearable of the customer.

It is to be understood that the displaying of fast-track deliverable add-ons can additionally or alternatively be performed via yet other display devices besides the primary display of the checkout registration device 115a or an added monitor 115c, for example on the customer's mobile phone 121p or even on an in-the-cart wireless display (not shown—where the in-the-cart wireless display is essentially as wide as the interior of the cart). Additionally or alternatively, an audio message or text message may be delivered to the customer reminding her of probably forgotten items (probably, meaning here more likely than not).

In an embodiment, another constraint on what can be listed as being fast-track deliverable add-ons on display monitor 115c is that of having a fast-track delivering mechanism (e.g., 118a, 118b, 118c, 119a, 119b) present and operational for timely delivering the selected fast-track item(s) to the customer before the customer leaves the store or venue and more specifically, to the customer's checkout location (e.g., current one 115a or an alternate secondary checkout location 116, or tertiary location 117c) within an associated fast-track delivery time limit 118t (118t′ or 118t″). In one embodiment, store clerks (e.g., those shown at 116a and 116b) are pre-positioned among the retail area shelves 112 or in the back room area 114 and equipped with their own mobile phones (e.g., 116p) or other communication devices for receiving automatically-generated orders identifying selected fast-track items and the locations (e.g., 115 or 116 or 117c) to which they are to be delivered as well as displaying a countdown of the allotted time 118t (or 118t′ or 118t″) for the respective deliveries.

The arrow-headed two-path combination 119a-118a shown in FIG. 1 represents a pickup of a requested add-on item from the front store shelves 112 and a delivery to the current checkout location 115 of the add-on requesting customer 121a. Paths combination 119a-118b represents a pickup of a requested add-on item from the front store shelves 112 but with delivery to a secondary location (e.g., secondary checkout location) 116 that the customer is directed to, for example because there are other customers (e.g., 122a) waiting on line for that first checkout location 115 with their respective carts or baskets (e.g., 122b) of to-be purchased goods and it would not be appropriate to make the latter wait longer (e.g., beyond 120 seconds) for delivery of the first customer's (121a's) selected add-ons to the primary checkout location 115. The secondary checkout location 116 can be situated a short distance away from the primary one (say 15 feet away) and may have its own checkout registration device similar to 115a for enabling completion of the checkout process there. Paths combination 119a-118c represents a pickup of a requested add-on item from the front store shelves 112 but with delivery to a farther away and tertiary location 117c that the customer is directed to, for example to her car in the parking lot because there is not enough time for the back of store clerks (e.g., 116b) to expeditiously make it to the primary or secondary checkout locations (115, 116) and yet the requesting customer is willing to wait longer (e.g., beyond 5 minutes but less than 20 minutes) for the desired add-on item.

Some deliverable add-on items may be located only in the back of store inventory area 114 (or in adjacent warehouse) rather than among the shelves 112. Substitution of path 119b for the above mentioned of path 119a represents the alternate option of delivery combinations originating from such a back of the store inventory area 114. Although two inventory handling store clerks 116a and 116b with their respective wireless communication devices 116p are illustrated, it is to be understood that there can be a greater number of such clerks distributed among the shelves 112 and/or in the back of the store inventory area 114 for performing at least part of the fast-track delivery operation for the requested add-on items. Additionally or alternatively, the pickup and/or delivery of requested fast-track items can be performed by automated robotic equipment (not shown). More specifically and in one embodiment, conveyor belts or pallet-guiding rails (not shown) may be disposed above the shelves 112 and/or in under-floor pathways. Additionally or alternatively customer-avoiding robots may be dispatched in place of human clerks for fetching requested fast-track add-ons and automatically bringing them to the customer location at a checkout position. For the case of conveyor belts or pallet-guiding rails, these conveying pathways may be enclosed in protective casings (not shown) having see-through panels which may serve as doorways for inserting or retrieving a fast-tracked item. In one embodiment, the inventory handling store clerk 116a picks up the requested add-on item, waits for a vacant spot on the overhead conveyor belt or for a vacant rail-guided pallet (not shown) and places the item there for automated delivery to the customer's current location (e.g., 115, 116 or 117c) or delivery to a position relatively near to the customer's current location. In one embodiment, certain oft-forgotten items of general customers of the store (e.g., milk, eggs, butter) are pre-stored in refrigeration units disposed at the checkout registration devices themselves 115a and are restocked on a regular basis.

In accordance with one embodiment of the present disclosure, a displayed recommendation (e.g., see briefly 315 of FIG. 3) on the fast-tracks add-ons display 115c does not necessarily have to be one that is delivered to the customer within a predetermined or context-determined short time limit (e.g., within 10 minutes). It is possible for the customer to be in a hurry to leave the store before a fast-track delivery can be made though she still very much wants the automatically recommended item. In such a case, she may at the checkout location make a quick request for future delivery (a non-fast-track delivery) to her home 117a or to another such distant location. Path 119c represents that non-fast-track delivery option. The X-ed out clock 118x indicates that a fast-track delivery time limit is not applicable for this delivery option. In one embodiment, the customer is charged extra for the to-the-home delivery. In one embodiment, if the customer selects multiple ones of the display-recommended items, a discount is provided for the to-the-home delivery process.

In a case where the tertiary delivery option 118c is elected and payment is not made for the requested fast-track item at the primary or secondary checkout location, the checkout and payment procedure may be carried out using the customer's smartphone 121p′ at the more distal location and/or using the smartphone 116p of the delivery-making store clerk (e.g., 116b). In the case where at home delivery is requested, the purchase is paid for at an appropriate one of the primary, secondary or tertiary checkout locations (115, 116, 117c) depending on how much time is estimated as needed for completion of the payment process.

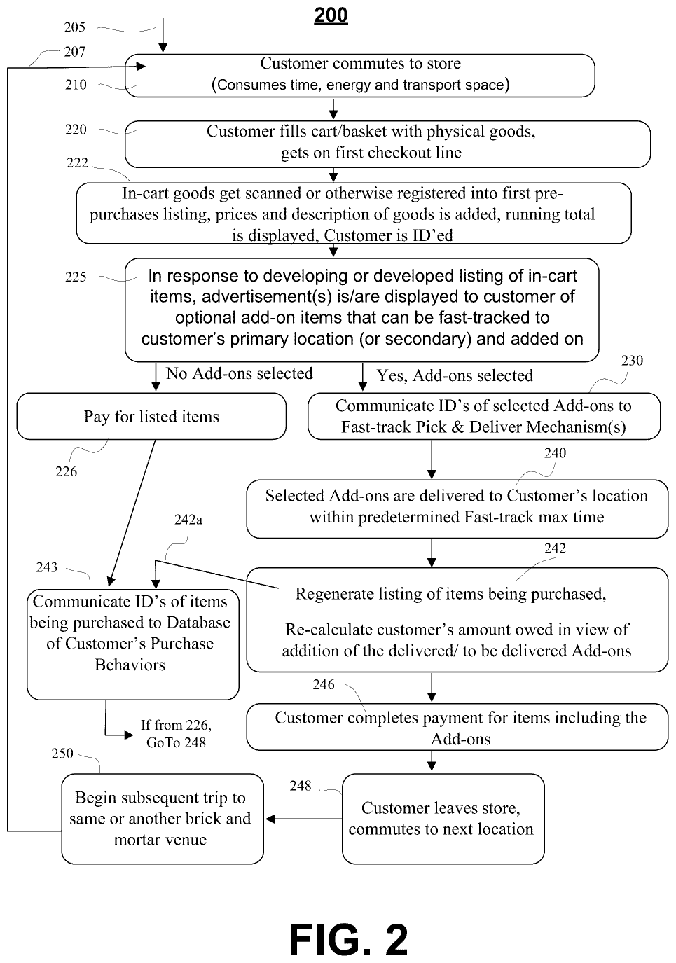

Referring to FIG. 2, a flowchart is shown for a method 200 in accordance with the present disclosure. Pathway 205 represents a first time entry into the method for a given store (e.g., 100) and customer while pathway 207 represents a second or subsequent reentry into the method for the given store or a same type but other brick-and-mortar store.

At step 210, a uniquely identifiable customer (also herein, the subject customer) commutes to the store by way of walking and/or by use of public and/or private vehicular transport. Invariably, the commute consumes money, time, energy (e.g., fuel, electricity, etc.) and transport space. The consumed transport space may include that of the customer occupying a seat in a public transport vehicle and/or that of the customer's vehicle (or the taxi) taking up road space. Generation of air pollution or other pollutants may occur as a result of the commute to the store in step 210. Also, energy is consumed. Accordingly, reducing the number of times that step 210 is carried out is beneficial to both the customer and the public in that such reduction reduces both private and public costs. The number of times that step 210 is carried out increases if the customer forgets an item, leaves the store and then has to commute back just to get the one forgotten item or a few such items.

At subsequent step 220, the identifiable customer has entered the store and filled his/her cart/basket with currently desired physical goods before getting on a first checkout line. Other customers may be waiting ahead of the subject customer for checkout of their respective goods. Thus, further time is consumed due to waiting by the subject customer for her turn; a step that the subject customer generally does not wish to unnecessarily repeat.

At subsequent step 222 the in-cart goods of the subject customer get scanned or otherwise registered so as to create a first pre-purchase listing of some or all of those in-cart goods where the listing provides respective descriptions of the goods, their quantities, their prices. Typically these will be displayed to the customer together with a running total for already registered ones of the goods. At the end of step 222, or preferably while the in-cart goods are still being scanned or otherwise registered (e.g., by way of the clerk typing in their descriptions), the unique identification of the subject customer will have been ascertained for example by the customer entering an associated telephone number, a credit card (preferably one issued by the store) and/or by means of biometric recognition and/or due to wireless communication with a personal wireless device (e.g., smartphone) possessed by the subject customer.

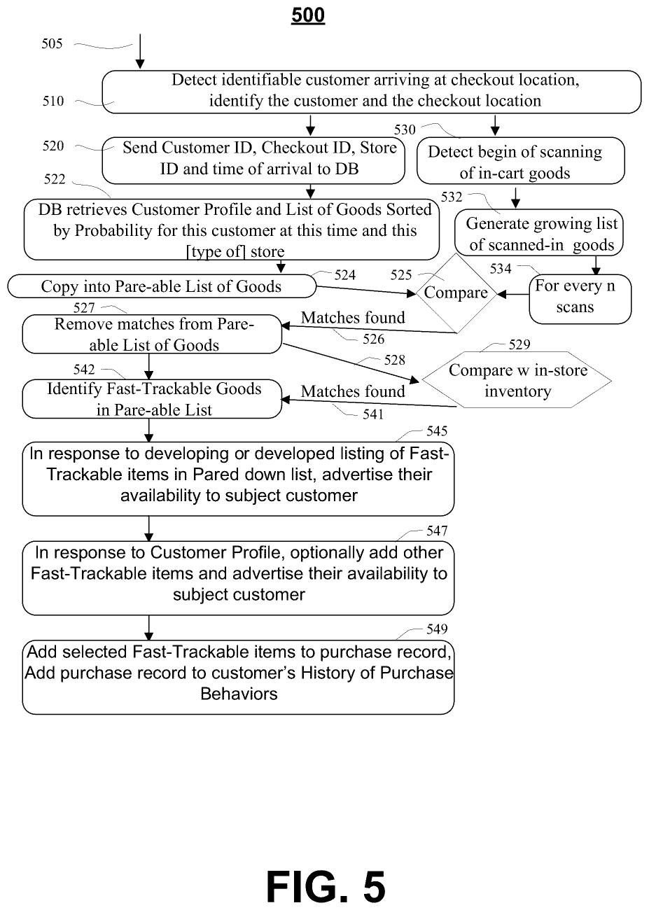

In a following step 225, and in response to a work-in-process (WIP) or completed development of the register-created and recorded listing of the in-cart goods, one or more advertisements is/are displayed to the subject customer of optional add-on items that can be fast-track delivered to the customer's primary location (e.g., 115 of FIG. 1) or if time does not permit, to a nearby secondary location (e.g., 116 of FIG. 1) or to a further away tertiary one (e.g., 117c of FIG. 1) as well as being added on to the customer's registered purchases either at the primary location (115) or at a further away secondary (116) or tertiary location (117). The one or more advertisements of optional add-on items can be generated using a bought-versus-ought-to-be-bought determining process as will be detailed later below. (See briefly steps 525-527 of FIG. 5.)

In a case where the subject customer does not pick any of the advertised add-on items for inclusion in his/her purchases, the method 200 proceeds to step 226 in which the subject customer pays for the registered items.

In subsequent step 243, a communication is automatically made of the respective identifications of the items that are being purchased and time and location of purchase to a database system that keeps track of the customer's purchasing behaviors at that specific store, or at the chain of stores or type of store. The communication identifies the specific store or type of store (e.g., supermarket, convenience store, pet shop, etc.) and the identification of the customer. As will be seen, repetition of the method via pathway 207 leads to a creation of a history of the customer's purchasing behaviors over time at different kinds of stores and/or while in different contextual situations, including that of how often the customer shops at that store or type of store, the average frequency at which specific goods or types of goods are purchased by the customer, the quantities purchased, the prices paid and so on. In one embodiment, behavioral trends (e.g., change of customer habits) are also automatically determined. For example, some items may become more favored over time by the customer while others less favored due to changing behaviors of the customer or of the customer's household, in particular as time of year or average weather conditions change (e.g., summer habits versus winter habits). In one embodiment, the system automatically repeatedly gathers weather condition information from known-to-be reliable internet sources (e.g., weather.com, wunderground.com). In one embodiment, the system automatically repeatedly gathers neighborhood contextual indications from known-to-be reliable internet sources (e.g., nextdoor.com) to understand what major events are happening in each geographical area (e.g., sports events, other entertainment events) and accordingly recommend beer; chips; etc. at the stores close to those events. In other words, a predictive model is built up over time for providing probabilities (e.g., sorted as most to least probable) of where and when the subject customer will likely want to again purchase specific goods or similar types of goods. The predictive model is then used to determine on a probability-prioritized basis, which of available fast-trackable items are to be recommended to the subject customer in step 225 and/or which ones are not to be then recommended. In one embodiment, the predictive model includes use of an artificial intelligence (AI) modeler such as a neural network that has been trained by the customer's history of purchasing behaviors and trends.

In an alternate case where the subject customer has selected one or more of the advertised-items of step 225, the method proceeds to step 230 in which the identification(s) of the selected add-on goods are communicated to a fast-track pickup and delivery mechanism. The pickup and delivery mechanism may involve the use of human clerks (e.g., 116a, 116b of FIG. 1) and/or conveyor belts and/or automated product conveying robots for completing the delivery of the requested add-on goods within respectively allotted times and to respectively appropriate delivery locations (e.g., 115, 116, 117c).

At step 240, the selected add-on goods are delivered to the customer's location (e.g., primary secondary or tertiary) preferably within a machine-determined fast-tracking maximum time limit (118t, 118t′ or 118t″). As already mentioned, the machine-determined fast tracking maximum time limit may be a fixed one (e.g., 60 seconds, 3 minutes, 5 minutes, 10 minutes, etc.) or it may be a variable, context-dependent time limit—for example when there are no other customers waiting in the registration line behind the subject customer, in which case it may be acceptable to enlarge the time limit, say by 50%. Although step 242 is illustrated as being subsequent to step 240, the steps can be performed concurrently. For example, the process of regenerating the listing of items being purchased and recalculating the customer's amount owed in view of the addition of the delivered or to-be delivered add-ons can occur even before the add-on items are actually delivered to the respective location. Simultaneously as indicated by communication path 242a, the identification of the items being purchased, including the selected add-on items is recorded in step 243 for communication to the database system that records the customer's purchasing behaviors. Control is passed from step 243 to step 248 if entry into step 243 was from step 226. Otherwise, control is passed to step 246 where the customer completes payment for the purchased items including the selected add-on items.

At step 248, the customer leaves the store venue while in possession of the purchased goods and commutes to a next location (e.g., back home). Step 250 occurs at a later time when the same customer begins making a subsequent trip to the same or to another brick-and-mortar venue. Then, as indicated by loop-back path 207, the customer completes the commute in step 210 from which the process 200 is repeated for the venue that the subject customer has commuted to.

FIG. 3A illustrates a nonlimiting first example of how a display 300 may be organized in accordance with the present disclosure for making fast-track add-on recommendations to a specific customer. The exemplary display 300 is divided to include a left side area 310 in which a currently prioritized item is being recommended and a right side area 320 which provides additional details of how the proposed delivery is to be made and/or offers suggestions for other “Fast Fetch” (FF) items that the customer might wish to have brought to her on a fast-track delivery basis.

More specifically, the left side area 310 includes an image 315 of the specific item being proposed for fast-track delivery. Here, in FIG. 3; reference numbers that are not being actually displayed are encased in hyphens; for example “-315-” for the displayed image of the exemplary carton of 2% milk of a specific brand and size that the subject customer routinely purchases at the subject store but forgot to include among her in-cart items. The system automatically knows about the details of the customer's favorite milk purchase based on her historical purchase behaviors as developed by repeated passage through step 243 in FIG. 2. In one embodiment, if that specific item is not in stock, the system automatically recommends an alike item with an indication that her favorite one is unfortunately not in stock.

Displayed item 312 provides a description of the recommended product 315, for example indicating to the customer that this is the milk product she routinely purchases every week but may have forgotten to include it or a suitable substitute in today's shopping cart. Displayed item 311 provides a large font, simple explanation of what is being proposed to be done; for example, “Fast Fetch” the below displayed item 315. Displayed item 316 may provide the proposed price for the item while displayed item 317 is an adjustable count for the quantity (e.g., number of cartons) that is to be purchased. Displayed item 318 suggests to the customer that she should approve the proposed add on item 315. In one embodiment, the request for approval may be a flashing touch-activated button or another such attention-grabbing indication combined with ability to approve the recommendation (or reject it via a cancel/close button 326).

The right side area 320 of the first exemplary display 300 can include additional information such as for example, the proposed location 322 (e.g., “HERE”) to where the add-on item is to be delivered and the time limit 323 (e.g., 60 seconds, 3 minutes, 5 minutes, 7 minutes, etc.) within which the delivery is to be made. Each of display items 322 and 323 may include a touch-activated drop-down menu which allows for variation either by the customer, the clerk at the register or by the automated system itself depending on the extant situation. More specifically, the automated system (see briefly FIG. 4) may determine that the proposed item 315 can no longer be delivered to the primary register (e.g., 115) within the initially allotted time (e.g., 180 seconds) and therefore the proposal is updated for delivery at a nearby secondary register (e.g., 116; say 15 feet away) and a slightly later time (e.g., within the next 5 minutes).

If the subject customer decides not to purchase the first proposed add-on item 315, displayed items 325 can provide additional recommendations of routine items that she normally purchases (e.g., purchases with greater than 49% probability) but were not yet detected as being included in today's in-cart items. For example, perhaps she forgot to purchase her once-per-week quantity of eggs, her weekly favorite bread, her once-per-moth puzzles-solving booklet (e.g., crosswords) or something else of that nature. Additionally, the store may have certain items that it wants to offer as fast-track items to the subject customer based on her known history and based on a desire to move those items more quickly off the shelves where those additional items have not yet been detected as already-in-her-cart items. That option may be displayed initially as an activateable touch button for “Our Daily Specials”. Then, if the customer elects to see the “Daily Specials”, a further screen is displayed providing reduced pricing information and other details. Additionally or alternatively, a further touch activateable button 328 may be provided for seeing a next screenfull of recommended Fast Fetch (FF) items. Alternatively, if no, or no further add-ons are desired, the customer or store clerk can activate the cancel/close button 326 and thereby cause the add-ons recommending display to close.

FIG. 3B illustrates another display format 350 in accordance with the present disclosure. Here a 3-by-3 matrix of recommended, fast-trackable items is displayed as having three horizontal rows 351, 352 and 353. The nine displayed items are contained in a corresponding set of nine matrix cells enumerated as 361 through 369, each showing an image of the product, its unit price and a textual description of the product as well as a check box (e.g., 381, 382, 383, . . . 386, etc.) indicating if the item is selected or not. In an alternate or further embodiment, each cell is color coded, for example green for yes and white for no to indicate if the cell item is selected. Although not shown, it is within the contemplation of the present disclosure to alternatively or additionally provide for audio descriptions of the products contained in the respective cells when a customer taps once on that cell. In one embodiment, a submit button 378 is provided to submit the checked items (e.g., 382, 386) as items that are to be fast-track delivered. In an alternate embodiment, a double tap or other kind of gesture may be used for approving of the recommended item. In one embodiment, the customer may also choose English or another language in which the audio description and/or textual description will be provided. In one embodiment, one or both of vertical scroll area 371 and horizontal scroll area 374 are optionally displayed together with their respective scroll control sliders 372 and 375. Thus, if the customer is not interested in any of the displayed items but nonetheless wants to see more recommendations, she can do so by operating the scroll control sliders. In one embodiment, a cancel/close button 379 is provided for closing the displayed matrix of add-ons when no or no further items are desired.

A variety of options are provided for what will be displayed depending on the purchasing behaviors profile of the subject customer. If the subject customer tends to be frugal and tends to buy only that which is immediately needed but was forgotten, the matrix will display only low cost items that are fast trackable and are sorted in accordance with the system's assessment of what the customer will most likely (and then second most likely, third most likely, etc.) want, but forgot to include in her cart. On the other hand, if the subject customer tends to be a spendthrift and tends to buy expensive items on impulse, the system will automatically offer the more expensive (and thus greater profit margin) items that the system has determined to be more probably desirable (e.g., greater than 40% chance) for that customer at this time and location. In other words, the system tries to maximize the total amount spent by the customer during this check out transaction while not wasting the customer's time or the checkout clerk's time by displaying items that are less likely (e.g., less than 40% chance) than other possible items to be now appealable to the subject customer as fast-track deliverables.

In one embodiment, up to five different categories of fast-trackable items are displayed, namely, (a) those that the subject customer most likely now needs (e.g., eggs 362 and ginger root 363, with greater than 40% chance); (b) on-shelf items whose sell-ability is declining with time and thus the store wishes to quickly move them off the shelves (e.g., fresh vegetables and fruits 369; perishable items such as milk 366); (c) on-shelf items that are being promoted via advertising, coupons etc. by their wholesalers (e.g., beer 361, premium ice cream 364, diet food products 365); (d) higher-priced impulse items that the subject customer is now more likely than not to purchase (e.g., fresh fish fillets 367) and (e) on-sale items that the subject customer is now likely to purchase due to an offered discount (e.g., 50% off frozen items 368). One or more of the matrix cells may be appropriately colored and/or flashed to draw attention to it or to selling attributes within the cell, such as the fact that the item in cell 368 is on sale for 50% off.

In one embodiment, the store's scanner (e.g., 115b) is used to inform the FT managing system of items that the store wishes to promote and/or offer discounts on. In such a case, the store manager scans in the bar or other code of the items and adds to the item description a special code that customer will not see but the FT managing system will detect, store as part of item's description and then automatically act on. For example, say there are five loaves of ABC bread on the store shelves that needs to be sold before June 21st. The store manager (or an authorized clerk) scans in the barcode of that ABC bread at a checkout counter and then (instead of a customer phone number) enters the following phrase in the place where the customer ID would go: DISC_5_50% JUN21. (In one embodiment, the discount code is prefixed or postfixed with a unique trigger code such as !##! to distinguish from any customer ID.) The FT managing system stores this information for the given bar code and then later recognizes it as indicating a store-promoted-item for which five such items need to be sold before June 21. Each time one of the promoted items sells, the stored count (initially “5”) is decreased. This way, the clerk/store manager does not have to go to a separate online portal or a separate computer terminal to enter identifications for store-promoted items. Instead, they can do it in a jiffy, right there at one of the checkout counters by inserting the FT-management-recognized code in place of the expected customer ID.

It is further within the contemplation of the present disclosure that interrelated products will be displayed adjacent to one another in the fast-track recommending matrix. For example, whipped cream and cherries might be displayed adjacent to the premium ice cream offering 364. Of course, if the store is recommending something other than food products; for example electronic products, the matrix offerings might include laptop computers, high-resolution displays and associated cables and other peripherals that will naturally be desirable to the subject customer while in that kind of checkout line.

Referring to FIG. 4, illustrated is a generalization of a machine system 400 configured for location and context sensitive checkout management where the system 400 includes portions for automatically determining respective identifications and checkout locations (e.g., LocU1, . . . , LocUm) of respective users (e.g., U1, U2, . . . , Um—customers and/or clerks) using their respective personal mobile devices (e.g., 415, . . . , 41m) carried and/or worn by the users and/or by using other means (e.g., credit card insertions, biometric recognitions) as the users approach or begin their respective checkout transactions or fast-tracking operations. In a case where a checkout transaction is completed in the parking lot (e.g., at vehicle 462), GPS 453 may be used to locate the customer. It is within the contemplation of the disclosure to use various types of scanners such as Wi-Fi ones (e.g., generation 5G ones that provide aimed beams 429a) to locate and identify respective customers or other users. It is within the contemplation of the present disclosure that the machine system 400 is configured to automatically repeatedly gather information from social media accounts (e.g., Facebook™, Twitter™, Instagram™) the respective customers for detecting special event aspects in the respective lives of those customers (e.g., birthdays, anniversaries, graduations, job promotions, Valentine's ay, Mother's Day, etc.) and to responsively add to the list of suggested add-ons, items routinely associated with those special events (e.g., birthday cake, birthday card, flowers, etc.) a few days before or on the day of the special occasion. It is within the contemplation of the present disclosure that the machine system 400 is configured to automatically repeatedly gather information from geographically local information sources of the store location (e.g., neighborhood news, town news, city news, county news, etc.) and to responsively add to the list of suggested add-ons, items routinely associated with reported events occurring in the local geographic region (e.g., sports events, other mass entertainment events, unique weather and/or other environmental events, unique traffic events, etc.) where the routinely associated items could be celebratory or precautionary items for dealing with those reported events (e.g., flashlights, batteries, extra water, snacks, drinks, etc.).

In general, most of the data processing devices (e.g., transactions registration device 401, barcode and/or QR code scanner 402, in-store server 436, smartphone 415) will include a CPU or alike data processing unit(s). The respective data processing units will be controlled by respective operating system software (OS) and will have installed therein other software or firmware (e.g., apps). Magnification area 415′ provides additional exemplary details for mobile device 415 of exemplary user U1. It is seen that this data processing device 415 has a predetermined operating system (OS) 413 currently executing within it. Device 415 may have a set of application program-to-OS interfaces (APIs) 414a for allowing various further programs 417 within the device 415 to access resources of its OS 413. In one embodiment, the OS allows for OS mediated control over local telephony interface resources 414b, local Wi-Fi interface resources 414c (e.g., including generation 5G resources), Bluetooth™ resources 414d, and GPS resources 414e. Others of the data processing devices illustrated in FIG. 4 (e.g., registration device 401, barcode and/or QR code scanner 402, in-store server 436, distal servers 440a, 440b) will have similar resources provided within them. It is to be understood that although some automated processes are described herein as being carried out by in-cloud servers (e.g., 440b), the specific location of process execution may be varied and may instead be carried out by the in-store server 436 and/or by otherwise located servers (e.g., elsewhere on the internet 420 such as by server 440a. One or more of the in-cloud servers (e.g., 440b) forms an automated fast-tracking management system (FT managing system) that includes a database 44m (FT managing DB) that keeps track of customer purchasing behaviors and associated data. The FT managing system can alternatively be disposed partly or wholly outside the cloud 430.

The schematic of FIG. 4 further depicts installation of one or more background peripheral services (BPSs) installed in area 418 of exemplary device 415. These services may be used to interact with corresponding communication resources within the store and/or outside. One of the BPSs could be one which transmits a Wi-Fi signal revealing the current GPS coordinates of the mobile device 415 as well as uniquely identifying the mobile device (e.g., by its currently assigned MAC or IMEI). The data of this Wi-Fi signal can be routed out via the internet 420 or otherwise to a server (e.g., 436 or 440b) controlled by the establishment. The establishment controlled server (e.g., 436) may then determine identity of the mobile device and of its owner based on the received GPS and/or other information and it may store the results for communication to a corresponding transactions managing system (e.g., an in-cloud 430 Fast-Track management system shown in FIG. 4 as being hosted by server 440b). In one embodiment, the establishment controlled server (e.g., 436) is used for storing a developing checkout record such that the developing checkout record can be transferred from a primary checkout location to a secondary or tertiary checkout location as a need for such transfer arises.

Importantly, at least one of three automatically repeatedly executing background services are installed in the checkout registration devices 401 of the store, namely, a background screen scraper 401a a background scan interceptor 402a and a background keyboard interceptor 403a. Functions for these will be detailed later below. One or more (e.g., any two or all three) of these background services 401a, 402a 403a may be functioning concurrently. Briefly, the screen scraper 401a repeatedly takes image scrapings (e.g., jpeg files) off the primary display of its associated registration device 401 and sends the scrapings to the FT managing system (e.g., to its FT database 44m). The FT managing system 440b converts (e.g., via an OCR process) the scraped images into intelligible digital information about what has been registered thus far at the registration device 401 and stores that intelligible information (e.g., in its FT database 44m). Briefly, the scan interceptor 402a detects and/or copies the scanning of each in-cart item and optionally sends the copy of the scan information to database 44m. The detection of each scanning may be used to determine how often to take screen scrapes and to send them to the database 44m as will be detailed later below. Additionally or alternatively, the copied scannings may be sent to the database 44m for conversion thereat (e.g., according to known protocol of the scanning device 402) into intelligible digital information about what is being registered as a registered item by use of the scanning device 402. The background keyboard interceptor 403a intercepts and copies keyboard entries made into the associated checkout registration device 401 and then sends the same to the FT managing system. Typically, the checkout keyboard is used by the store clerk to register items (e.g., fruits, vegetables) that do not have barcodes on them. By receiving the intercepted keyboard entries, the FT managing system can keep track of not only the bar-encoded items checked through the associated checkout registration device 401 but also the via-keyboard registered items. The intercepted keyboard entries can also be used to instruct the FT managing system of specially promoted items.

Various foreground programs may be used by the user (e.g., U1) while waiting at a checkout line and/or waiting for provisioning of requested fast-track goods. These programs are depicted as being present in area 417 of device 415. APIs to the local apps in the mobile device are depicted as being present in area 414f. One of the foreground programs that may be running in region 417 in accordance with one embodiment is that displaying the store's current on-sale offerings or explaining how the fast-track process works. These may be used to pre-condition the customer into buying some of the fast-trackable offerings of that store. Additionally or alternatively, smart display panels (not shown) may be provided on the shopping carts and may provide same or similar advertisements. As part of an example for touch-activated screens, a programs launching GUI for the mobile device is depicted at 415 with application invoking icons such as 411 and 412 being present on the displayed graphical user interface. One of the application invoking icons (e.g., 411 or 412) may cause a launching of the store's advertising application, another of its FF tutorial videos. These applications may be stored in area 417 after being downloaded for example from a store-serving computer server 440b located in cloud 430 or another disposed elsewhere on the Internet 420.

FIG. 4 more broadly depicts an integrated client-server/internet/cloud system 400 (or more generically, an integrated multi-device system 400) within which the here disclosed technology may be implemented. System 400 may be understood as being an automated machine system having distributed intelligent resources including a variety of differently-located data processing and data communication mechanisms including for example, the user-carried/worn mobile wireless units (e.g., wireless smartphones 415, . . . , 41m) configured to allow end-users thereof (e.g., U1, U2 . . . . Um) to invoke from respective end-user occupied locations (e.g., LocU1) services from differently located enterprise hosts (e.g., on-internet 420 and/or in-cloud servers 440a, 440b, etc.). In one embodiment, server 440a handles the downloading of in-store ordering and order progress advisement apps into mobile devices that request them. The downloading process may include generating unique customer profiles (e.g., including billing information) and customer identifications that are to be used when the respective customers need to be identified (e.g., at checkout time). In one embodiment the in-cloud server 440b handles the managing of placed FT orders. Server 440b may include or connect to an order management database 44m which keeps track for each order-placing user (e.g., user Um, where m is an integer) of: (a) the user's customer profile 44m.1, (b) the details of currently and previously made purchases 44m.2; (c) the current specific one or type of store the customer is located at 44m.5; (d) the delivery status of items that are being fast-tracked 44m.6; (e) information about wait times of at register customers 44m.7; and (f) purchase information obtained via screen scraping of the register 401 (by scraper 401a) and/or intercept of the scanner's (402) readings (by interceptor 402a)—the latter to be more fully explained below.

It is to be understood that the illustrated configuration of system 400 is merely exemplary. As indicated, it comprises at least a few, but more typically a very large number (e.g., thousands) of end-users U1, . . . . Um located at various types of stores with their respective communication devices 415 (only a few shown in the form of wireless smartphones but understood to represent many similarly situated mobile and/or stationary client machines—including the smartphone wireless client kinds, smart watches, and cable-connected desktop kinds). These end-user devices 415 and/or also the registration devices 401, scrapers 401a, scan interceptors 402a, etc., are capable of originating service requests which are ultimately forwarded to service-providing host machines (e.g., in-cloud servers like 440b) within a cloud environment 430 or otherwise on-internet or linked-to internet machines (e.g., 440a). Results from the service-providing host machines are thereafter typically returned to the end-user devices (415, . . . 41m, 401) and displayed or otherwise communicated to the end-users (e.g., U1, U2, . . . , Um, m being an integer). In one embodiment, the end-user (U1) can have installed into his/her smartphone (415) a software application (“app” 417) that automatically requests from the Fast-Track managing system (in server 440b), a list of items that the subject customer routinely buys at the current venue and under the current contextual situation. The customer may then use the list to remind herself even before arriving at the checkout counter 115 of what items to place in her shopping cart.

In one embodiment, upon receiving respective detection of an identifiable customer arriving at a checkout location 401 and identifying that customer, the local server 436 connects via the Internet 420 to the fast-track managing system 440b. The fast-track managing system (e.g., server 440b) uses the relayed customer ID as well as a co-relayed store ID and checkout location ID to pull out a suitable customer profile 44m.1 for that store or for that type of store and optionally for that type of checkout location (e.g., self-service checkout) for thereby determining context-appropriate advertisements to be displayed to that customer. In doing so, the fast-track managing system 440b may consult with an accessible expert knowledge base 456 (example shown in server 440′) or an artificial intelligence (AI) subsystem to determine, based on the relayed detections, what the one or more most likely current behaviors of the customer will be at the respective venue and for the extant conditions there; More specifically, what FT items to now recommend to the subject customer and in what order.

Aside from the end-user devices (e.g., 415, . . . , 41m) and the cloud servers (e.g., 440b) the system 400 comprises: one or more wired and/or wireless communication fabrics 416, 425, 435 (shown in the form of bidirectional interconnects) intercoupling the checkout registration devices 401 (also optionally, the scanner 402) and end-user client devices (e.g., 415, . . . , 41m) directly or indirectly with the various networked servers (e.g., 436, 440a, 440b, 440′).

Still referring to FIG. 4, a further walk through is provided here with respect to detailed components that may be found in one or more of the mobile devices and/or respective servers. Item 411 represents a first user-activateable software application (first mobile app) that may be launched from within the exemplary mobile client 415 (e.g., a smartphone, but could instead be a tablet, a laptop, a wearable computing device; i.e. smartwatch or other). Item 412 represents a second such user-activateable software application (second mobile app) and generally there are many more. Each end-user installed application (e.g., 411, 412) can come in the form of nontransiently recorded digital code (i.e. object code or source code) that is defined and stored in a memory for instructing a target class of data processing units to perform in accordance with end-user-side defined application programs (‘mobile apps’ for short) as well as to cooperate with server side applications implemented on the other side of communications links 416, 425, etc. In one embodiment and the case where an order is placed for respective goods and/or services by way of a non-mobile or not normally used client machine (e.g., a checkout registration device 401, a desktop computer, etc.), the order management server 440b automatically recognizes this condition and acts accordingly.

More generally, each app (e.g., 411, 412, 417, those installed in register 401 namely, 401a, 402a, 403a) may come from a different business or other enterprise and may require the assistance of various and different online resources (e.g., Internet, Intranet and/or cloud computing resources). Each enterprise may be responsible for maintaining in good operating order its portions of the system (e.g., local scanners, local servers, Internet, Intranet and/or cloud computing resources). Accordingly, the system 400 is shown as including in at least one server 440′, an expert knowledge base and/or AI 456 which contains various kinds of different expert rules or trained neural nets for handling different conditions. One set of expert rules may provide for optimized customer identification and location determination. Another set of expert rules/AI-nets may provide for variable location determination based on different sets of furniture layout at each respective venue. Yet other of the expert rules/AI-nets may relate to categorizing different types of transactions and details about how to handle them, including how to resolve various problematic issues.

In addition to the expert knowledge base and/or AI-nets 456, one or more other portions of the system 400 may contain interaction tracking resources 451 configured for tracking interactions between customers and respective vendors and an interactions and behaviors storing database 452 configured for storing and recalling the tracked interactions and behaviors. Links 453a (to a further server 440c), 453b, 453c and 453d represent various ways in which the system resources may communicate one with the other.

As mentioned, block 440′ is representative of various resources that may be found in client computers and/or the various servers. These resources may include one or more local data processing units (e.g., CPU's 441), one or more local data storage units (e.g., RAM's 442, ROM's 443, Disks 446), one or more local data communication units (e.g., COMM units 447), and a local backbone (e.g., local bus 445) that operatively couples them together as well as optionally coupling them to yet further ones of local resources 448. The other local resources 448 may include, but are not limited to, specialized high speed graphics processing units (GPU's, not shown), specialized high speed digital signal processing units (DSPU's, not shown), custom programmable logic units (e.g., FPGA's, not shown), analog-to-digital interface units (A/D/A units, not shown), parallel data processing units (e.g., SIMD's, MIMD's, not shown), local user interface terminals and so on.

It is to be understood that various ones of the merely exemplary and illustrated, “local” resource units (e.g., 441-448) may include or may be differentiated into more refined kinds. For example, the local CPU's (only one shown as 441) may include single core, multicore and integrated-with-GPU kinds. The local storage units (e.g., 442, 443, 446) may include high speed SRAM, DRAM kinds as well as configured for reprogrammable, nonvolatile solid state data storage (SSD) and/or magnetic and/or other phase change kinds. The local communication-implementing units (only one shown as 447) may operatively couple to various external data communicating links such as wired, wireless, long range, short range, serial, parallel, optical kinds typically operating in accordance with various ones of predetermined communication protocols (e.g., internet transfer protocols, TCP/IP, Wi-Fi, Bluetooth™ and so on). Similarly, the other local resources (only one shown as 448) may operatively couple to various external electromagnetic or other linkages 448a and typically operate in accordance with various ones of predetermined operating protocols. Additionally, various kinds of local software and/or firmware may be operatively installed in one or more of the local storage units (e.g., 442, 443, 446) for execution by the local data processing units (e.g., 441) and for operative interaction with one another. The various kinds of local software and/or firmware may include different operating systems (OS's), various security features (e.g., firewalls), different networking programs (e.g., web browsers), different application programs (e.g., product ordering, customer profiling, game playing, social media use, etc.) and so on.

The advantages of the present teachings over the art are numerous. It is to be understood that the present teachings are not to be limited to specific disclosed embodiments. In the above description and for sake of simplicity, a supermarket venue (100) is described. However, this disclosure may be applied, but not limited to, shopping malls containing boutique and chain stores, theaters (e.g., purchase of snacks, souvenir's therein), stadiums, arenas, train stations, airports, big box stores, and so on; including venues that provide automated vending machines with graphical displays (again preferably, where the displays are of resolution 1K or greater and areas much larger than ordinary smartphones; e.g., 8× or greater). In other words, in most situations where it may be desirable to remind customers at checkout time about items they may have forgotten to include in their checkout cart/basket.

The take away by a customer from a point of sale (POS) device of physical goods while having legal title to the goods (having purchased the goods) need not be limited to traditional checkout counters (e.g., 115 of FIG. 1) at supermarkets. Consider a fuel pump at a gasoline station venue. The device can have a credit card or other mechanism for authorizing payment as well as a computer-driven display of resolution 1K or greater and a display area much larger than that of ordinary smartphones (e.g., 8× or greater). The customer typically inserts or otherwise presents a personal credit card or other personal financial authorization device (e.g., a payment-authorizing smartphone 121p) to the fuel pumping device. Thus the customer can thereby be automatically identified before or as the dispensing of fuel (e.g., gasoline, diesel) into the customer's vehicle or container commences and whereafter the customer leaves the POS device with possession of the dispensed fuel(s). It is within the contemplation of the present disclosure to have a liquid fuel dispensing and/or electric power recharging device co-function as a fast-track add-ons recommending and/or FT delivery location.

For example, the gasoline or other fuel/energy dispensing device can be disposed at a venue (e.g., gasoline station) having a convenience annex store and/or vending machine nearby. The add-ons recommending display of the fuel/energy dispensing device can be driven by an algorithm that automatically asks, while the customer is waiting for the fuel/energy to be dispensed; whether the customer wants chips, cookies, water bottles, sandwiches, etc. and can then cause an FT delivery to the customer location before the customer leaves the fuel/energy dispensing device. The FT delivery to the customer location can be by way of clerks dispatched from the store annex or goods automatically dispensed from a vending machine adjacent to the fuel/energy dispensing device. Additionally or alternatively, some of the add-ons may be pre-bagged (or otherwise packaged) in the annex store—ready for the customer to simply pick up and leave with.

FT add-on recommendations may also be made at a stand-alone vending machine having suitable display and payment authorization means. In the case of automated vending machines having graphic interfaces such as touchscreen displays, the add-on recommendations/suggestions can be made based on what was most recently registered or purchased, without even the need for a customer ID and returned profile. For example, if someone buys microwaveable popcorn, the algorithm can automatically suggest to buy soda along with popcorn or vice versa.

In accordance with a further aspect of the present disclosure, a “clustering-of-stores” in the vicinity of a central dispensing device (e.g., fuel/energy pump) is contemplated here. The add-ons recommending display of the central dispensing device can list add-ons that are FT-obtainable be from a cluster of stores near to the central dispensing device. An example would be stores near to a gas station, that are walkable to/from for a 50˜100 foot distance. The stores of the cluster pre-agree to participate in such FT-clustering and to timely deliver the FT-add-on items to the central dispensing device when requested. More specifically, if there is a “XYZ juice store” in a premise next door to the gas station; and if “fresh orange juice” of a given brand/size is the customer's favorite, it will show up in the add-ons recommending display of fuel/energy dispensing device (e.g., gas pump). If the customer selects that FT-add-on it will be the responsibility of the “XYZ juice store” to timely deliver the same to the customer's location. Stated otherwise, in the case of “clustering-of-stores”, the add-ons recommending display can show recommended items that are FT-deliverable from the inventories of plural stores (including nearby food trucks, kiosks, etc.) rather than from just one store. The “clustering-of-stores” approach can benefit all involved. More specifically, the fuel/energy dispensing device can function as a purchasing anchor point because all vehicles at some point in time will need re-fueling/re-charging. The adjacent stores will benefit from the clustering agreement because the customer may not have stopped merely for the add-on item (e.g., juice) but will have stopped for the necessary fuel and/or energy dispensing. When choosing a fuel/energy dispensing location, the customer may take into account the advantage of there being a cluster of FT-delivery participating stores around the chosen central dispenser. The customer benefits from not having to stop his/her vehicle in an additional spot beyond the central dispenser because FT-delivery is made possible by way of a walkable distance (say 50˜100 feet) or at a distance allowing for timely FT-delivery (say 3˜20 minutes).

In one embodiment, a store can opt-in/opt-out of the “clustering program” at anytime. When a store opts out, its FT-deliverables are no longer recommended on the add-ons recommending display of the central dispensing device. When a nearby store opts-in, its FT-deliverables begin to be recommended on the add-ons recommending display of the central dispensing device. It is to be understood that the opting-in store need not even have the FAST-TRACK Addon software fully installed in their system. All they have to do is to include their real-time inventory listing as a sub-catalogue to the real-time inventory listing of the central dispensing venue (e.g., the gas station) to couple their order taking software (e.g., their clerks' mobile phones) to receive the FT-delivery requests directed to that sub-catalogue. This can be done via in-cloud services. For example, Amazon Web Services (AWS) offers such capabilities. That way,—to stick with the example—whenever an orange juice order is placed on the gas pump LCD screen or at the gas station convenience store POS system, the orange juice order goes to the clerk's mobile phone at the next door XYZ juice store. The order-receiving clerk then delivers the juice within the allotted time to the customer at the gas pump (or at gas station). This method will be very helpful for a non-anchor Mom & Pop store (e.g., the XYZ juice store) in that it can tag on to the non-competing sales made at next door anchor store.

Examples of non-compete clusterings to an anchor location can include Mom & Pop store nearby to an automobile accessory store (like OReilly™, Autozone™, etc.); nearby to big box hardware stores (like Home Depot™, Lowe's™ etc.); nearby to a) supermarket or a local grocery store; nearby to a popular clothing store, a footwear store; an electronics store, a flower shop; a plants nursery; a liquor store; a cosmetics store; a men's/women's accessories store (e.g., sunglasses, belts, jewelry, handbags, etc.); an art supplies store (for canvases, paints, brushes, pencils, etc.); a bakery (for cakes, pastries, etc.); a coffee shop (e.g., Starbucks™, Peets™); a juice/ice-cream/pizza/sandwich shop; a bookstore; a toy store; a pet store (like Petco™ PetSmart™, etc.); a furniture store; a beauty salon (e.g., one suggesting a volumizing shampoo after a haircut); a drug store (e.g., reminding patients of their daily/weekly/monthly medicines and supplements (both prescription & non-prescription), OTC alternatives, seasonal allergy medicines, seasonal vaccines, etc.); a restaurant (where in case of restaurants, the reminder/recommendation like “Chef's special”, “Seasonal Special”, “Your favorite”, “Pair/Try this with that” (Ex: Red wine with Gnocchi/Tequila with Nachos, etc.) will be provided at the table when the waitress/waiter takes the order with a mobile device. Customer ID may not be needed. They will be needed only if reminding of any personal favorite dishes. If the customer had recently bought a cold medicine at a pharmacy, the add-ons recommending display can suggest a “HOT Soup” at the nearby restaurant or grocery for relief of their symptoms. If the customer often buys frozen lasagna at grocery stores, the add-ons recommending display can suggest “Veg Lasagna” at the nearby restaurant (if available in today's menu).

The FT add-ons recommending method can detect a customer's habitual purchasing pattern at one type of a physical store (e.g., grocery store) and use the same to suggest items at a noncompeting different type of physical store (e.g., restaurant). Overall, this aspect can be implemented for many kinds of brick-and-mortar stores to remind at-checkout customers about items they may have forgotten to include in their checkout basket. Some of the suggested items can also be based on: a) local weather or other local environmental conditions (suggesting canned cold drinks on hot days; hot coffee on cold days, head coverings on high UV days or rain days); b) time of the day (if lunch time, the recommendation can be some lunch specials available at the food section of the store) and c) special days of the month or year (e.g., items desired on certain holidays, for example Thanksgiving, or special personal days like birthdays). More specifically as an example, at many big box stores (e.g., Costco™) they may have low cost food offerings as loss leaders to draw customers in especially around meal times (e.g., Costco™ Pizza; or Wholefoods™ has a buffet style food department). In accordance with an aspect of the present disclosure, during a conventional meal time period (e.g., around 11 am-1 pm), the fast-track recommendation system can automatically suggest to the at-checkout customer to have their breakfast/lunch/dinner meal there at the store itself rather than leaving. This keeps the customer at the store for a longer time and increases possibility of making more sales.

In accordance with an aspect of the present disclosure, when there is special event near the checkout location—for example a sports game at a nearby stadium—the fast-track recommendation system can automatically push to sell more items associated with the nearby special event. More specifically, it may automatically suggest buying beer and chips to customers whose profiles indicate they are sports fans and they also make purchases at a liquor store. Yet More specifically, the fast-track recommendation display might say, “It's Super Bowl™ soon-stock up on these Party Items”. On hot days it might say, “It's hot! Cool yourself with . . . ”. These are examples. The idea here is to integrate external factors that are not exclusive to the POS (the store checkout location) with the customer's profile (e.g., external events like weather, sports events, news events, holidays, etc.), and thereby proactively tempt the customers to buy more items at the POS based on the combination of the external factor(s) and the customer's known propensities extracted from that customer's latest profile.

FIG. 5 illustrates a method 500 in accordance with the present disclosure for determining what in-cart items a subject customer is having entered into a current registration device (e.g., 401) and also determining what normally purchased items or store-promoted items are missing from the cart.

Entry is made via path 505 into step 510 where the system automatically detects the arrival of an identifiable customer at an identifiable checkout location in an identifiable brick-and-mortar store. The identity of the customer can be ascertained in one or more of numerous ways including, but not limited to: (a) having the customer present a scannable identification card to the register scanner 402; (b) having the customer enter his/her telephone number into an accessible keypad (or having the clerk do the same for the customer); (c) automatically recognizing the customer by way of facial and/or other biometric identification techniques; (d) wirelessly extracting the customer identification from a smartphone or other such wireless device possessed by the customer; and (e) using a credit card supplied by the customer to a credit card reader to thereby determine the customer's identification. The identification of the checkout location can be ascertained from a unique machine access code (MAC or IMEI) assigned to the local registration device (e.g., 401) and/or to the local product scanning device (e.g., 402).

In a following step 520, the determined customer identification (ID), the determined checkout location are automatically sent to the fast-track managing system (e.g., 440b) together with an identification of the store in which the subject check out transaction is taking place, a timestamp for the transaction and optionally other contextual information respecting how the transaction is taking place (e.g., self-checkout or by a store clerk). Responsively, in step 522 the FT-managing system retrieves (or creates, if the first time) the customer profile 44m.1 and, based on determined context (e.g., store type, time of week, time of day, local weather or other local environmental conditions, local traffic conditions, commutation means by which the customer commuted to the store, etc.) a list of goods that the subject customer will most likely be purchasing at the store based on the detected local or personal context. The retrieved list may be presorted to list the items with the highest probability first of being desired by the subject customer and then in descending order of probability.

At step 524, the context-based list is copied into a memory location from which some of the items may be deleted as information comes in about what items the subject customer is having registered into the local registration device (e.g., 401). This will become the pared-down list of items to recommend but which the subject customer may have forgotten (or which the store is promoting). In concurrent step 530, detection begins of the scanning of the in-cart goods. This detection 530 can be based on scanner readings noted by the scan interceptor 402a, the keyboard interceptor 403a, and/or the generation of registered items on the register display as detected by the screen scraper 401a. In one embodiment, the installed screen scraper 401a does not have the intelligence to determine the nature of the information it collects from repeatedly scraping the images on the register display. Instead, the screen scraper 401a automatically sends the screen scraped image to the FT-managing system 440b and the latter uses optical character recognition (OCR) services that it has to convert the image information into recognizable digital information that reveals what product has been scanned, what the register description of that product is, what the per-unit or total prices, what the quantity is and other such useful information for determining what items should be removed from the pare-down-able list of step 524. In one embodiment, the FT-managing database 44m stores templates for specific stores or chains of stores that reveals the format of the scraped information, for example which column will hold the price data, which the product code, which the quantity amount and so on. Extraneous information is automatically discarded.

In accordance with one aspect of the disclosure, rather than having OCR conversion performed for every individual item that is scanned, the screen scraper 401a waits for a predetermined number, n of such items to have been scanned (e.g., every 3 items, every 5 items, etc.; where the current number of scans is a modulo n value determined due to counted scan detections by the scan interceptor 402a and counted keyboard registrations detected by keyboard interceptor 403a) before sending the scraped screen image to the FT-managing system 440b. This way the number of individual communications between the local registration device 401 in the store and the elsewhere located (e.g., in the cloud) FT-managing system 440b can be reduced. In addition to sending scrapings and keyboard intercepts based on number of detected scans/keyboard entries, the screen scraper 401a will automatically send its scrapings to the FT-managing system 440b when a predetermined amount of time has elapsed (e.g., 30 seconds) and no new scans have been detected. The latter may occur for example when registration of all the in-cart items is complete and a total amount for the being-purchased items is being displayed on the register display.

In an alternate embodiment, rather than relying on screen scrapings, a copy of each barcode (and/or QR-code) scanning is sent to the FT-managing system 440b and the latter converts the raw scanner data into a pseudo-copy of what appears on the in-store primary display of the registration device. In this case, the FT-managing system 440b stores templates for specific stores or chains of stores that reveals the protocol used by the scanner 402 and the format used by the in-store registration device 401, for example, what the product code is and what the associated description is for each scannable item, which column will hold the price data, which the product code, which the quantity amount and so on.

Step 525 performs a comparison between the intelligible information extracted from the screen scrapings (or scanner extractions) and the current copy of the pare-able list of goods of step 524. If one or more substantial matches are found (control path 526), the substantially matching items are removed in step 527 from the current pare-able list of goods. This will eventually leave behind a list of goods that the subject customer routinely purchases under the current context (and/or the store is currently promoting) but the customer did not include in his or her basket of being registered goods. By ‘substantially matching’ it is meant here that the in-cart item is a suitable substitute for what the customer more routinely purchases, for example, Brand B milk in a small container rather than the customer's usual Brand A milk in a larger container. If the customer chose to the Brand B milk in the small container rather than her usual Brand A milk in the larger container this time, there's no point in recommending the latter to her. Perhaps she is trending to a new purchasing pattern. This will become evident to the AI or expert system 456 as more purchase are later made. The AI or expert system is pre-trained or programmed to automatically recognize what constitutes a suitable substitute.

In accordance with one aspect of the present disclosure, even if there is an item that is likely to have been forgotten; that alone is not enough for recommending that item to the subject customer as a fast-trackable add-on. Control path 528 first consults with comparison step 529 to make sure that each item in the ultimately pared-down list is currently present in the current store inventory and can be delivered to the subject customer at customer acceptable location (e.g., 115, 116, 117c) within a system determined, maximum time limit for fast-track delivery of that item. If yes, then control returns via path 541 to step 542 where the fast-trackable items in the pared-down list are checked off as being fast-trackable goods.

Responsively, in step 545, the items that have been checked off as being fast-trackable goods and as having the highest probability of being currently desired by the subject customer are advertised to the customer on an appropriate display (e.g., 115c, 300, 350) and/or by audible or texting means. As noted above, the advertising of the recommended fast-trackable items need not occur on a separate FT add-ons display such as 115c shown in FIG. 1. Instead or additionally, the advertisement can be displayed on the customer's smartphone 121p. Instead or additionally, the advertisement can be displayed on an in-cart display unit (not shown) provided by the store as affixed to the customer's cart 121b and wirelessly coupled to the fast-track managing system. Instead or additionally, the advertisement can be displayed on the primary display of the local registration device 115a.

Aside from displaying fast-trackable ones of the items that the subject customer likely forgot, it is within the contemplation of the present disclosure to optionally add other fast-trackable items to the availability advertisement based on the customer's retrieved profile and/or based on the local store's current priorities; such as for example moving soon-to be-expired items off its shelves and moving vendor-promoted items. This can be done in step 547.

If the subject customer selects one or more of the advertised fast-trackable items, then in step 549 the selected items are added to the customer's purchase record and the updated purchase record is sent back to the FT-managing system 440b for inclusion in the customers purchases history 44m.2. In this way, the predictive model of the customer's purchase behaviors can be updated to include the customer's most recent behaviors. In one embodiment, time-based weighting is applied to the predictive model so that older behaviors have less weight and more recent behaviors are given greater weight when determining what items the subject customer is most likely to desire.

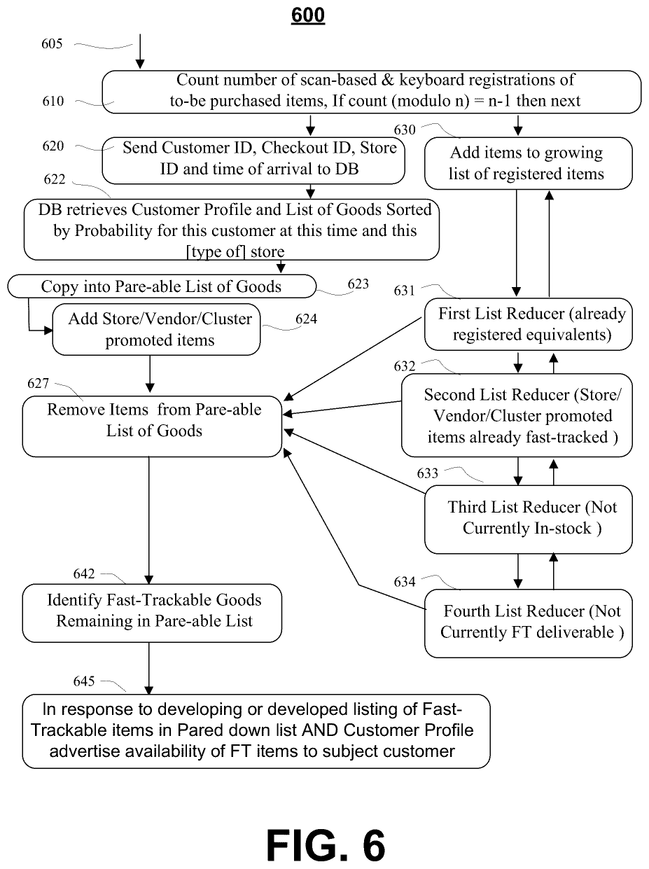

FIG. 6 provides a flowchart 600 illustrating additional details about a method embodiment in accordance with the present disclosure. Entry may be made at position 605. In step 610 the method automatically counts the number of scanned-based and keyboard registrations of to-be purchased items. Each time a modulo n function of the count it's a predetermined value; say n−1, the process advances to steps 630 and 620 before looping back to step 610. (Here n is the number of collected scan registrations and keyboard registrations appearing on the register display that merit sending the collection to the FT managing system before some of them disappear off the register display.)

In step 630 the collected scan registrations and keyboard registrations are used to add their items to a growing list of already-registered items. In concurrent step 620, the collected scan registrations and keyboard registrations are communicated (optionally with encryption) to the FT managing system together with the customer's identification, the identification of the store or venue (venue could be a center of a cluster of physical product providers) and an identification of the checkout location. The communication may further include a timestamp indicating a local time at which that portion of the transaction occurred.

In step 622 the FT managing system retrieves from its database (DB) the current profile of the customers purchasing habits and responsively the FT managing system generates a list of goods that the subject customer is most likely to wish to purchase for the given type of store or the given specific store or associated cluster of stores and for the given local time as well as based on optional external factors (e.g., weather; holidays; local arena events, etc.).

In subsequent step 623, the generated list of likely goods (preferably sorted to list most probable goods first and then less probable goods) is copied into a parable-down list in a memory of the system. The memory holding the parable-down list may be located in a store-controlled server (locally or remotely in the internet) or in the cloud. At subsequent step 624, the parable-down list is expanded by adding to it, store-promoted, vendor-promoted and or cluster-promoted items.

In subsequent step 627, the expanded list is automatically repeatedly reduced (pared down) based on actions of concurrently executing steps 631, 632, 633 and 634.

Step 631 is a first list reducer which looks to see what the already-registered items are at the checkout location and if there are substantially matching items (for example exactly matching items) in the current parable-down list. If yes, they are removed from the parable-down list.

Step 632 is a second list reducer which looks to see if any items in the current parable-down list have already been selected for fast-track delivery to the customer. If yes they are removed from the parable-down list.

Step 633 checks the current inventories of the local store and/or optionally of the nearby in-the-cluster stores to verify that items currently in the parable-down list are in stock in the respective inventories. If no, those no longer available items are removed from the parable-down list.

Step 634 checks the current status of the respective fast-track delivery mechanisms of the local store and optionally those of the nearby in-the-cluster to verify that the respective fast-track delivery mechanisms are currently operable for timely delivery of respective items still remaining in the parable-down list. If one or more of the fast-track delivery mechanisms is currently inoperable (in other words cannot timely deliver the respective goods), the affected items are removed from the parable-down list by way of step 627. The operations of the list-reducing steps 631, 632, 633 and 634 keep repeating as step 630 adds new items to the growing list of registered items and optionally as steps 623 and 624 add new items to the parable-down list.

After steps 631-634 have executed at least once, and preferably more times based on how many items are being registered, subsequent step 642 automatically identifies as being fast-trackable goods, those goods that remain in the parable-down list.

Subsequent step 645 intakes the list of identified fast-trackable goods and, based on their probability of desirability by the customer (as indicated by the customer's profile) and then advertises them sequentially or in limited numbers (e.g., in the 3×3 grid) to the subject customer for optional selection by that customer. When the subject customer selects one of these advertised items, they are fast-track delivered because step 633 has verified that they are currently in stock and step 634 has verified that their respective fast-track delivering mechanisms (e.g., mobile-equipped clerks, robots, conveyor belts and/or rails) are currently operable.

In accordance with various embodiments of the present disclosure, the methods described herein may be implemented using one or more hardware computer systems that execute software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a digital processor of a digital programmable computer or other programmable data processing apparatus to produce a machine, such that the instructions, which execute via the processor of the computer or other programmable instruction execution apparatus, create a mechanism for implementing the functions/acts specified in the flowchart and/or block diagram block or blocks. All instructions need not be executed by a same one processor and can instead be distributed among a plurality of operatively cooperative processors. The terminology, ‘at least one processor’ as used herein is to be understood as covering both options, namely having one processor execute the all instructions or distributing the instructions for execution by two or more processors.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously or on an interrupted multi-tasking basis and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claimed subject matter.

What is claimed is:

1. A machine-implemented method that detects presence of respective customers at respective brick-and-mortar stores and reminds the detected customers at or before checkout time of respective items the respective customers are probably forgetting to bring to respective checkout locations, the machine-implemented method comprising:
detecting presence of a subject customer at a respective brick-and-mortar store that has one or more checkout locations;
creating for the subject customer, a pare-down-able list of items the subject customer routinely purchases at the respective brick-and-mortar store or its type of store and under a current context of the subject customer;
detecting items that the subject customer is having registered at a current checkout location and deleting from the pare-down-able list, substantially matching ones if any of the detected items that the subject customer is having registered;
determining which, if any, of remaining items in the pare-down-able list are fast-track deliverable items based on the store's current inventory, the fast-track deliverable items being ones that can be timely delivered to the subject customer before that customer leaves the respective brick-and-mortar store or a surrounding venue of that store; and
advising the subject customer as to the availability of the fast-track deliverable items.

2. The method of claim 1 wherein;
said detecting of the presence of the subject customer includes identifying the subject customer when the subject customer arrives at a primary checkout location of the respective brick-and-mortar store.

3. The method of claim 2 wherein said creating for the subject customer of the pare-down-able list of items the subject customer routinely purchases comprises:
sending to a fast-track (FT) managing system, the identity of the subject customer, an identity of the respective brick-and-mortar store and an indication of when the subject customer arrived at the primary checkout location, the FT managing system being one that maintains a history of what items the subject customer bought at the respective brick-and-mortar store and/or its type of store;
receiving responsively from the FT managing system, a list of items the subject customer has routinely purchased at the respective brick-and-mortar store and/or its type of store; and
using the received list as at least part of the created pare-down-able list.

4. The method of claim 3 wherein;
the FT managing system organizes its maintained history for each of plural customers according to at least one of type of store and specific store.

5. The method of claim 4 wherein;
the FT managing system organizes its maintained history for each of plural customers according to time of purchase and optionally other contextual aspect of each respective purchase.

6. The method of claim 4 wherein the other contextual aspect of each respective purchase includes at least one of:
(a) day of week of when the purchase is being made;
(b) part of month or year of when the purchase is being made;
(c) whether the purchase is being made by way of registration at a self-checkout register or another kind of register;
(d) method used by the subject customer to commute to the respective brick-and-mortar store;
(e) method probably to be used by the subject customer to commute away from the respective brick-and-mortar store;
(f) method used to identify the subject customer;
(g) method planned to be used by the subject customer to pay for the purchase;
(h) local weather and or other local environmental conditions;
(i) local traffic conditions; and
(j) local mass entertainment events.

7. The method of claim 1 wherein said determining which, if any, of remaining items in the pare-down-able list are fast-track deliverable items includes at least one of:
determining if the fast-track deliverable items can be timely delivered to the subject customer at the subject customer's current checkout location;
determining if the fast-track deliverable items can be timely delivered to the subject customer at an in-store secondary checkout location; and
determining if the fast-track deliverable items can be timely delivered to the subject customer at an out-of-store tertiary checkout location.

8. The method of claim 7 wherein said timely delivery is at least one of:
within a predetermined maximum time limit based on the type of store; and
a computed maximum time limit based on the type of store, number of other customers waiting at the current checkout location of the subject customer and contextual state of the subject customer.

9. The method of claim 8 wherein said timely delivery is the predetermined maximum time limit, where the latter is 15 minutes or less.

10. The method of claim 9 wherein the predetermined maximum time limit is 7 minutes or less.

11. The method of claim 9 wherein the predetermined maximum time limit is 5 minutes or less.

12. The method of claim 9 wherein the predetermined maximum time limit is 3 minutes or less.

13. The method of claim 8 wherein said timely delivery is the computed maximum time limit and the contextual state of the subject customer is based on whether the checkout location of the subject customer will be a first arrived at checkout location of the subject customer or a further away other checkout location for the subject customer.

14. An automated recommendation system for recommending to a subject customer at a brick-and-mortar store, add-on items for addition to items registered for the subject customer at a checkout register of the brick-and-mortar store; the system comprising:
an automated screen scraper that automatically repeatedly scrapes imagery of a display screen of the checkout register;
an automated fast-track (FT) managing system that receives the imagery scrapings of the screen scraper and responsively returns to a memory device of the automated recommendation system, a pare-down-able list of items the subject customer routinely purchases at the brick-and-mortar store or its type of store and under a current context of the subject customer; and
a display configured to display to the subject customer a recommended add-on item that appeared in the pare-down-able list of items but was not substantially matched by registration of a same or like item at the checkout register.

15. The automated recommendation system of claim 14 wherein the FT managing system includes an optical character recognition service that converts the received imagery scrapings into intelligible digital data.

16. The automated recommendation system of claim 15 wherein the intelligible digital data includes a description of the items registered for the subject customer and displayed on the display screen of the checkout register, an indication of price to be paid for the items registered; and an indication of quantity of the items registered for the subject customer.

17. An automated fast tracking system for delivering to a subject customer at a brick-and-mortar store, add-on items to be added to items already registered for the subject customer at a checkout register of the brick-and-mortar store; the system comprising:
an automated fast-track (FT) managing system that receives information about the items already registered for the subject customer and in response returns to a memory device of the system, a pare-down-able list of items the subject customer routinely purchases at the brick-and-mortar store or its type of store and under a current context of the subject customer;
a first list reducer that compares the items already registered for the subject customer versus the items in the pare-down-able list of items and removes from the pare-down-able list those of its items that are substantially matched by the items already registered;
a second list reducer that determines if remaining items in the pare-down-able list of items are currently in-stock for the brick-and-mortar store and removes from the pare-down-able list those of its items that are not in-stock;
a fast-track order placer that automatically places an order for an item in the pare-down-able list that is currently in-stock and has been requested by the subject customer as a fast-track add-on; and
a fast-track delivery mechanism responsive to the fast-track order placer and structured to deliver the requested fast-track add-on item to the subject customer before the subject customer leaves the store or the store's venue.

18. The automated fast tracking system of claim 17 wherein the fast-track delivery mechanism includes wireless communicators for communicating the automatically placed order of the fast-track order placer.

19. The automated fast tracking system of claim 17 wherein the fast-track delivery mechanism includes an automated conveyor for carrying out at least part of the delivering of the requested fast-track add-on item to the subject customer before the subject customer leaves the store or the store's venue.

20. The automated fast tracking system of claim 17 wherein the delivering of the requested fast-track add-on item to the subject customer before the subject customer leaves the store or the store's venue occurs within 15 minutes or less of the subject customer having requested the item as a fast-track add-on.
